(19) United States
(12) Patent Application Publication
(10) Pub. No.: US 2010/0319196 A1
(43) Pub. Date: Dec. 23, 2010

(54) Mounting kit and method for forming a recess in a concrete celling

(75) Inventor: Maik ROSENBERG, Attendorn (DE)

Correspondence Address: DENNISON, SCHULTZ & MACDONALD, 1727 KING STREET, SUITE 105, ALEXANDRIA, VA, 22314, US

(73) Assignee: AQUATHERM BESITZGESELLSCHAFT GMBH & CO., KG, Attendorn (DE)

(21) Appl. No.: 12/711,290

(22) Filed: Feb. 24, 2010

(30) Foreign Application Priority Data
Jun. 19, 2009 (DE) 20 2009 004 938.8

(51) Int. Cl. A62C 35/58; B65D 69/00

(52) U.S. Cl. 29/897.3; 206/231; 29/890.1

(57) ABSTRACT

A mounting kit and a method for connecting a sprinkler head to a coupling piece with threading, which is cast into a concrete ceiling. To enable installation of a sprinkler head concealed or visible in concrete ceilings, without costly steps for forming recesses in the concrete ceiling, it is proposed that the mounting kit include a hollow cylindrical cap with an end surface that is closed toward the outside of the concrete ceiling, a sleeve that encompasses the perimeter of the cap and a threaded element, which can be screwed into the threading and which separably connects the sleeve to the coupling piece. When the concrete ceiling is being cast, the cap is fastened to or on the concrete formwork on the outside of the concrete ceiling.

The invention further relates to a method for forming a recess in a concrete ceiling and for using said recess to position a sprinkler head to be connected to a sprinkler pipeline in a concealed or visible position.

A concealed sprinkler arranged in a concrete ceiling is known from WO-A-2006/105758. In the area of the sprinkler, the concrete ceiling has a recess in which a pipe with a threaded connector ends, into which connector the sprinkler can be screwed.

US-A-2008/0060823 also refers to a concealed sprinkler assembly. To form a corresponding cavity required to accommodate a sprinkler head in a concrete ceiling, a cap can be screwed onto an elbow piece of a water supply pipe, which can be cast into a concrete ceiling, wherein a hollow cylindrical element with an angled, flange-type edge around its perimeter can be inserted into said cap and then used to connect the element to the concrete ceiling. Once the concrete ceiling has been cured, the threaded element can be removed and replaced by a sprinkler head.

The subject of DE-C-101 40 942 is a supply system for fire-extinguishing agent. In this case, a sprinkler projects outward from a flexible pipe that is cast into a concrete ceiling. To protect the flexible pipe and its sprinkler head coupling piece from exposure to undesirable forces during casting, fastening means are provided, via which the pipe connector for the sprinkler head is connected to a concrete formwork.

The object of the present invention is to provide a mounting kit and a method which will make it possible to install sprinklers in concrete ceilings in a concealed or a visible position, without costly steps for forming recesses in the concrete ceiling.

To attain this object, the invention provides essentially that the mounting kit comprises
a hollow cylindrical cap, the end surface of which is closed toward the outside of the concrete ceiling,
a sleeve encompassing the cap around its perimeter and
a threaded element that can be screwed into the threading and separably connects the sleeve with the coupling piece,
   wherein during casting of the concrete ceiling, the cap is fastened to or on the formwork on the outside of the concrete ceiling.

According to the invention, a mounting kit is provided in the shape of a can having an inner cap and a sleeve encompassing said cap, with the cross-section of the sleeve in the area of the closed end surface of the cap being larger than the area distant from the end surface, wherein in the latter area the sleeve has an edge area that points toward the inside, with which the sleeve can be connected to the coupling piece. The edge area that points toward the inside is continuous and surrounds an opening, through which the threaded element extends, and which is covered on the interior by a flange of the threaded element. This creates a closed unit which concrete cannot penetrate.

The cap has at least one opening in its closed end surface, through which a fastening element, such as a threaded element, can be inserted and connected to the concrete formwork.

For assembly, first the cap, preferably in the shape of a can, is screwed using at least one screw onto the formwork of the concrete ceiling to be cast. Four, five or six openings, for example, and therefore four, five or six screws, are preferably provided for securing the cap. The sleeve is then screwed onto the coupling piece via the threaded element. The coupling piece is equipped with internal threading, into which the sprinkler head, with its external threading, can be screwed. In this case, customary threading is used, for example ½″, ¾″ or 1″ threading. The sleeve that is connected to the coupling piece is connected to the cap, i.e., pushed together. The coupling piece can then be connected, or may already be connected, directly to a pipe such as a downpipe, or via an elbow piece to a pipe via which fire-extinguishing water can be supplied when the sprinkler system is in operation. The elbow piece or pipe is connected to the reinforcement, for example via connectors, in the concrete ceiling that is to be cast, and is thereby fastened.

Once the concrete has been cast and cured, the formwork is removed in a known manner. Because both the sleeve with the coupling piece and the cap are connected to the formwork, when the formwork is removed the cap is removed along with it. The screw element is then removed, allowing the sleeve to be pulled out of the concrete ceiling. This also uncovers the threading of the coupling piece, so that the sprinkler can be mounted directly or optionally via an adapter fitting.

The invention further relates to a method for forming a recess in a concrete ceiling and for using said recess to position a sprinkler head to be connected to a sprinkler pipeline in a concealed or visible position.

To accurately and smoothly form a recess and to position a sprinkler head in a concealed or visible position in said recess or projecting out of said recess, the following process steps are proposed:
a) connecting a can-shaped cap to a formwork to be used in casting the concrete ceiling,
b) connecting a sleeve to a coupling piece, which is or will be connected in turn to a pipe or an elbow piece that projects out of said pipe,
c) joining sleeve and cap,
d) casting the concrete ceiling,
e) removing the formwork with the cap attached to it,
f) separating the sleeve from the coupling piece and
g) connecting the sprinkler head to the coupling piece.

In this process, the sequence of process steps a) and b) may be reversed.

It is also possible to screw an adapter piece onto the coupling piece, and to then connect the sprinkler head to said adapter. This allows the sprinkler head to be installed in a visible position.

In particular, it is provided that a sleeve is used, the exterior of which is conical in shape, with its cross-section narrowing in the direction of the coupling piece.

The invention is further characterized in that a sleeve is used, which at its connecting end has an edge area that points toward the inside, at least in sections, via which area the sleeve can be connected to the coupling piece. In particular, it is provided that the edge area that points toward the inside extends between a flange of a threaded element and the coupling piece.

Cap and sleeve should be made of plastic.

Further details, benefits and characterizing features of the invention are specified not only in the claims, the characterizing features contained therein—alone and/or in combination—, but also in the following description of a preferred exemplary embodiment presented in the set of drawings.

The drawings show:

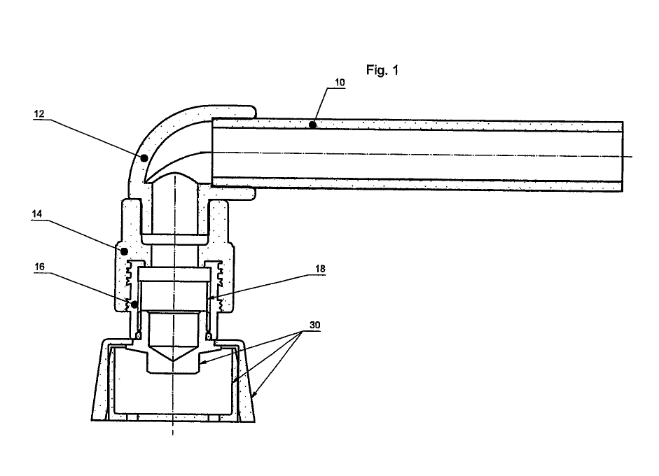

FIG. 1 a section of a mounting kit with coupling piece and pipeline,

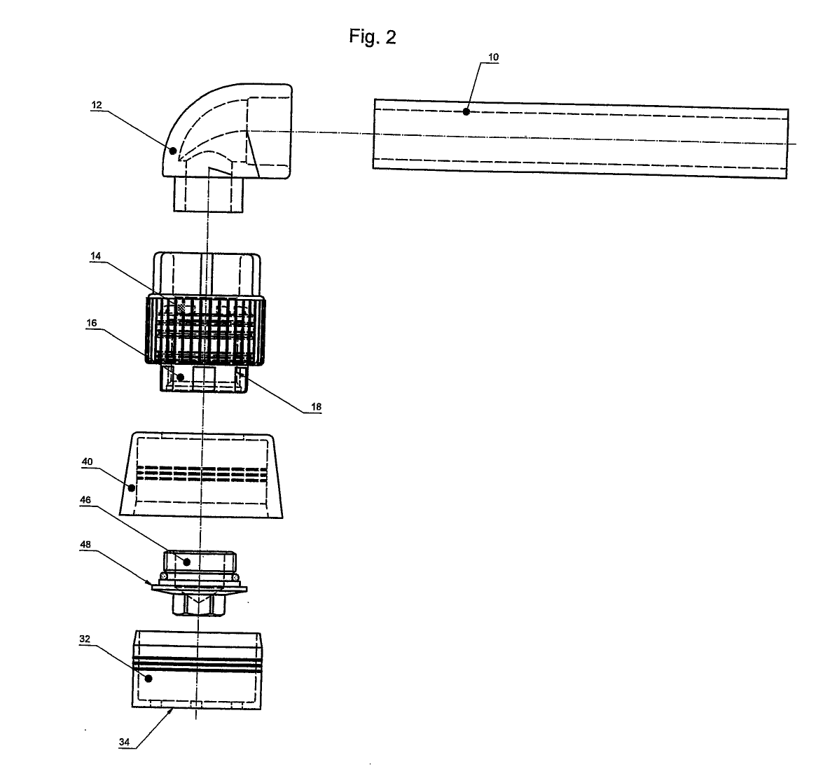

FIG. 2 an exploded view of the mounting kit with coupling piece and pipeline of FIG. 1,

FIG. 3 a perspective view of a cap, as seen from the inside,

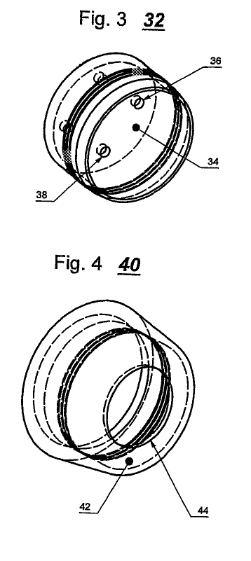

FIG. 4 a perspective view of a sleeve, as seen from the outside,

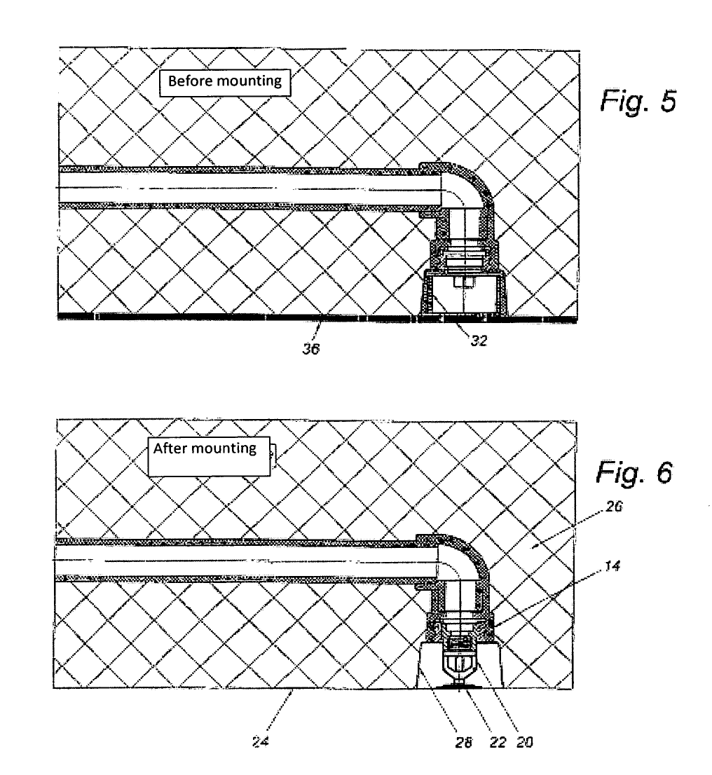

FIG. 5 the mounting kit of FIG. 1 with coupling piece and pipeline in its status prior to mounting and

FIG. 6 a sprinkler in the concealed embodiment, connected to the coupling piece of FIG. 5.

To position sprinklers in a concealed or optionally visible arrangement in a concrete ceiling, the ceiling must be equipped with corresponding recesses at those points where sprinklers will be provided, with coupling pieces, which are cast into the concrete and are connected to pipes that supply water for extinguishing fire, ending in said recesses.

In FIG. 1, a section of a corresponding pipeline 10 is connected via an elbow piece 12 to a coupling piece 14, which has an insert 16 with internal threading 18. A sprinkler head 20 can then be screwed into the internal threading 18, wherein according to the exemplary embodiment of FIG. 6, the sprinkler head 20 is arranged concealed in a recess 28 in a concrete ceiling 26, in other words a disk sprayer 22 extends approximately within the plane that is spanned by the exterior 24 of the concrete ceiling 26.

Of course, an adapter fitting, in other words an extender, can also be screwed into the coupling piece 14, i.e., its threading 18, with the sprinkler head then being screwed into said fitting, so that the head projects outward beyond the concrete ceiling 26.

To form a corresponding recess 28 for the sprinkler 20 in the concrete ceiling 26, a mounting kit 30 is cast into the concrete ceiling 26, and is removed once the ceiling is cured. The mounting kit 30 will be specified in greater detail in reference to FIG. 1 through 4.

The mounting kit 30 comprises a cylindrical cap 32 with a closed end surface 34, in other words basically can-shaped, which is attached to a formwork 36 to be used in casting the concrete ceiling 26. To this end, the end surface 34 has openings 36, 38, as shown in FIG. 3, through which screws can be inserted to attach the cap 32 to the formwork.

The mounting kit 30 also has a sleeve 40, the interior shape of which matches the outer shape of the cap 32. In the exemplary embodiment, a hollow cylindrical shape is chosen, to allow the cap 32 to be produced easily as an injection molded piece.

Externally, the sleeve 40 is conical in shape, with an end surface 42 that has an opening 44 and extends in the area of the cone that is smaller in diameter. The opposite end is open to allow the sleeve 40 to be placed on the cap 32.

A threaded element 46 is inserted through the opening 44 and can be screwed into the interior threading 18 of the insert 16 of the coupling piece 14. The threaded element 46 has a flange 48, the diameter of which is greater than that of the opening 44. As a result, when the threaded element 46 is screwed into the interior threading 18 of the insert 46, the sleeve 40 is also connected to the coupling piece 14. The interior threading 18 is configured to match the external threading of the sprinkler head 20.

Mounting then proceeds as follows:

First, the cap 32 is screwed onto the concrete formwork 36 at a desired location. Using the threaded element 46, the sleeve 40 is connected to the coupling piece 14, which is in turn connected to the elbow piece 12 and to the pipe 10. The unit formed in this manner is placed on the cap 32, so that the concrete ceiling 26 can be cast. Once the concrete ceiling 26 has cured, the formwork 36 is removed. Because the cap 32 is connected to the formwork 36, the cap 32 is pulled out of the sleeve 40 at the same time. The threaded element 46 is then removed, allowing the sleeve 40 to be pulled out of the concrete ceiling. The sprinkler head 20 is then screwed into the internal threading 18 of the insert 16 in the coupling piece 14.

1. Mounting kit for connecting a sprinkler head (20) to a coupling piece (14, 16) with threading (18), which has been cast into a concrete ceiling (26), the mounting kit comprising:
a hollow cylindrical cap (32) with an end surface (34) that is closed toward the outside of the concrete ceiling (34),
a sleeve (40) that encompasses the entire perimeter of the cap and
a threaded element (46) that can be screwed into the threading (18) and can be used to separably connect the sleeve to the coupling piece (14, 16),
wherein when the concrete ceiling is being cast, the cap is fastened to or on the concrete formwork on the outside of the concrete ceiling.

2. Mounting kit of claim 1, characterized in that the exterior of the sleeve (40) is conical in shape, with its cross-section in the area of the closed end surface (34) of the cap (32) being larger than in the end area that is remote from this surface.

3. Mounting kit of claim 1, characterized in that the sleeve (40) with its end surface extending on the connecting side has an edge area (42) that points toward the inside at least in sections, via which the sleeve can be connected to the coupling piece (14, 16).

4. Mounting kit of claim 3, characterized in that the edge area (42) that points toward the inside extends between a flange (48) of the threaded element (46) and the coupling piece (14, 16).

5. Mounting kit of claim 4, characterized in that the edge area (42) that points toward the inside is embodied as continuous.

6. Mounting kit of claim 1, characterized in that the cap (32) has at least one opening (36, 38), through which a fastening element such as a screw can be inserted, and can be connected to the concrete formwork (36).

7. Mounting kit of claim 1, characterized in that the cap (32) and the sleeve (40) are made of plastic.

8. Method for forming a recess in a concrete ceiling and for using said recess to position a sprinkler head to be connected to a sprinkler pipe in a concealed or visible arrangement, comprising the steps of:
a) connecting a can-shaped cap to a formwork to be used in casting the concrete ceiling,
b) connecting a sleeve to a coupling piece, which in turn is or will be connected to a pipe or to an elbow piece of the sprinkler pipeline extending from said pipe,
c) joining sleeve and cap,
d) casting the concrete ceiling,
e) removing the formwork with the cap attached to it, and
f) separating the sleeve of the sprinkler head with the coupling piece.

9. Method of claim 8, characterized in that the sequence of process steps a) and b) is reversed.

10. Method of claim 8, characterized in that before connecting the sprinkler head to the pipe or elbow piece, an adapter piece is connected to the latter, with the sprinkler head then being connected to said adapter piece.

11. Method of claim 8, characterized in that a sleeve is used, the exterior of which is conical in shape, with a cross-section that narrows in the direction of the coupling piece.

12. Method of claim 8, characterized in that a sleeve is used, which at its end area on the coupling side has an edge area that points toward the inside, at least in sections, via which the sleeve is connected to the coupling piece.

13. Method of claim 12, characterized in that
the edge area that points toward the inside is arranged between the coupling piece and a flange of a threaded element with external threading, which corresponds to that of the sprinkler head.
